(19) United States
(12) Patent Application Publication
(10) Pub. No.: US 2018/0114302 A1
(43) Pub. Date: Apr. 26, 2018

(54) LIGHTNING STRIKE INCONSISTENCY AIRCRAFT DISPATCH MOBILE DISPOSITION TOOL

(71) Applicant: The Boeing Company, Chicago, IL (US)

(72) Inventor: Gregory James Sweers, Renton, WA (US)

(21) Appl. No.: 15/331,864

(22) Filed: Oct. 23, 2016

(51) Int. Cl. G06T 7/00; H04N 13/02; H04N 5/225; G06K 9/62

(52) U.S. Cl. CPC G06T 7/001; H04N 13/0203; G06K 9/6202; G06K 9/6267; H04N 5/2252

(57) ABSTRACT

A device including housing and a sensing module in the housing and configured to detect a lightning-caused inconsistency on an aircraft. The device also includes a data capture module in the housing and configured to capture images of the lightning-caused inconsistency. The device also includes an analysis module in the housing and configured to characterize characteristics of the lightning-caused inconsistency using the images and to compare the characteristics to a preexisting data set.

### BACKGROUND INFORMATION

### 1. Field

The present disclosure relates to methods and devices for characterizing characteristics of lightning-caused inconsistencies using images, and other sensor data, in order to compare the characteristics to a preexisting data set.

### 2. Background

Current inspection for inconsistencies and benchmarking of an aircraft after a lightning strike requires a large amount of time to complete. Such inspection and benchmarking is usually performed by an aircraft operator. In many cases, additional undesirable time is required to communicate with a manufacturer on inconsistency details and proposed action plans of the aircraft operator. Thus, methods and devices for increasing both the speed and accuracy of inspection and benchmarking would be desirable.

### SUMMARY

The illustrative embodiments provide for a device including a housing and a sensing module in the housing and configured to detect a lightning-caused inconsistency on an aircraft. The device also includes a data capture module in the housing and configured to capture images of the lightning-caused inconsistency. The device also includes an analysis module in the housing and configured to characterize characteristics of the lightning-caused inconsistency using the images and to compare the characteristics to a preexisting data set.

The illustrative embodiments also provide for a method. The method includes moving a device around outside surfaces of an aircraft. The device includes a housing and a sensing module in the housing and configured to detect a lightning-caused inconsistency on the aircraft. The device also includes a data capture module in the housing and configured to capture images of the lightning-caused inconsistency. The device also includes an analysis module in the housing and configured to characterize characteristics of the lightning-caused inconsistency using the images and to compare the characteristics to a preexisting data set. The method also includes sensing the lightning-caused inconsistency with the sensing module. The method also includes scanning the outside surfaces of the aircraft with the data capture module and capturing images of the lightning-caused inconsistency. The method also includes characterizing, by the analysis module, the characteristics of the lightning-caused inconsistency using the images. The method also includes comparing, with the analysis module, the characteristics to a pre-existing data set to form a comparison. The method also includes determining, with the analysis module, whether the aircraft is airworthy based on the comparison, wherein a determination is formed. The method also includes transmitting the determination to a display device.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft, in accordance with an illustrative embodiment;

FIG. 2 is an illustration of a flowchart comparing current lightning-induced inconsistency reworking techniques with current lightning-induced inconsistency reworking techniques, in accordance with an illustrative embodiment;

FIG. 3 is an illustration of a block diagram of a device for performing lightning-induced inconsistency assessment and benchmarking, in accordance with an illustrative embodiment;

FIG. 4 is an illustration of a flowchart for reworking lightning-induced inconsistencies on an aircraft, in accordance with an illustrative embodiment; and

FIG. 5 is an illustration of a data processing system, in accordance with an illustrative embodiment.

### DETAILED DESCRIPTION

The illustrative embodiments recognize and take into account that current techniques for inspecting aircraft and other composite structures for lightning-induced inconsistencies, and benchmarking such inconsistencies, require a large amount of time to complete. Additional significant time may be spent communicating with the aircraft manufacturer on inconsistency details and proposed aircraft operator action plans.

Current lightning strike inspections take about an 8-hour shift with a full crew of about 6 technicians to complete the inspection and inconsistency benchmarking. Inconsistency benchmarking is done by using a grease pen on the aircraft structure to draw grids that assist with communicating inconsistency size. Current processes also include use of a magnifying glass, of about 10 power magnification typically, to examine each fastener and structural skin location.

As indicated above, once an inconsistency is found and verified, a grease pen is used to indicate a grid of standard measure around the inconsistency used to communicate inconsistency size to engineering organizations. Several communication chains are normally created due to inconsistency description and location clarifications, resulting in higher costs for the manufacturer. A major aircraft manufacturer typically spends about 14,000 person-hours on supporting maintenance of lightning-induced inconsistencies.

Thus, the illustrative embodiments provide for a tool that replaces and enhances current human inspection with a magnifying glass already in place requiring a maintenance technician to crawl the entire acreage of the aircraft inspecting and benchmarking lightning-induced inconsistencies. The tool of the illustrative embodiments also automates the disposition of the inconsistency to provide an indication whether the aircraft can be dispatched into continued operation for specified limited amount of time or cycles without reworking the inconsistency.

The illustrative embodiments also provide for a hand-held or suspended tool (possibly from a fixed point or unmanned aerial vehicle (UAV) sometimes colloquially referred to as a drone) that combines dimensional data capture capability with internal inconsistency analysis capable of leveraging normal structural conditions intellectual data as a nominal data set to compare to information collected by the tool. This tool is made up of data capture hardware to capture images in three dimensions, heat inconsistency indication sensing, and structural inconsistency information combined with inconsistency assessment dispatch logic.

The tool of the illustrative embodiments has a spatial awareness capability utilizing three-dimensional laser mapping technology and internal aircraft design three-dimensional maps to confirm exact locations on the aircraft structure. For location identification, the device utilizes aircraft on-board sensors to triangulate the devices image to capture position using comparator logic to determine lightning strike inconsistency specific location (frame, station, stringer, etc.).

The device may display an image on a screen that indicates alignment of an aircraft structure to actual recorded images providing confirmation of the location of the inconsistency and affected drawings. Alternatively or in addition, the device may project a grid onto the aircraft itself, thereby replacing the grease pen, hand-drawn grid described above.

The device of the illustrative embodiments is capable of measuring lightning strike inconsistency depth and size in a square area. Inconsistency information is gathered by the tool using design data and projecting a dimensional grid around the inconsistency site to quickly indicate the significance of the inconsistency.

Strike characterization information stored within the tool provides the ability for the tool to indicate whether immediate reworking is needed, or if limited operation is recommended. The tool of the illustrative embodiments may make available information, wirelessly, to outside resources for documenting the inconsistency and further analysis, if desired. Transmittal of inconsistency images may be superimposed with the structural elements involved and a grid around the inconsistency marking the inconsistency size.

Structural inconsistency information collected and compared to internally stored standards by the tool is used within an internal logic to assess a dispatch ability of the aircraft with known inconsistencies documented during the benchmarking procedure, which is also performed by the tool. Applying allowable lightning-induced inconsistency limit information in comparison to the benchmarked inconsistencies, the tool assists the user in planning aircraft utilization.

Thus, the tool of the illustrative embodiments provides for an advanced data capture capability, making the nominal design data available, and ease of use. The tool of the illustrative embodiments will significantly reduce the down time caused by lightning-induced inconsistencies borne by the aircraft operator and also significantly reduce associated support costs borne by the aircraft manufacturer.

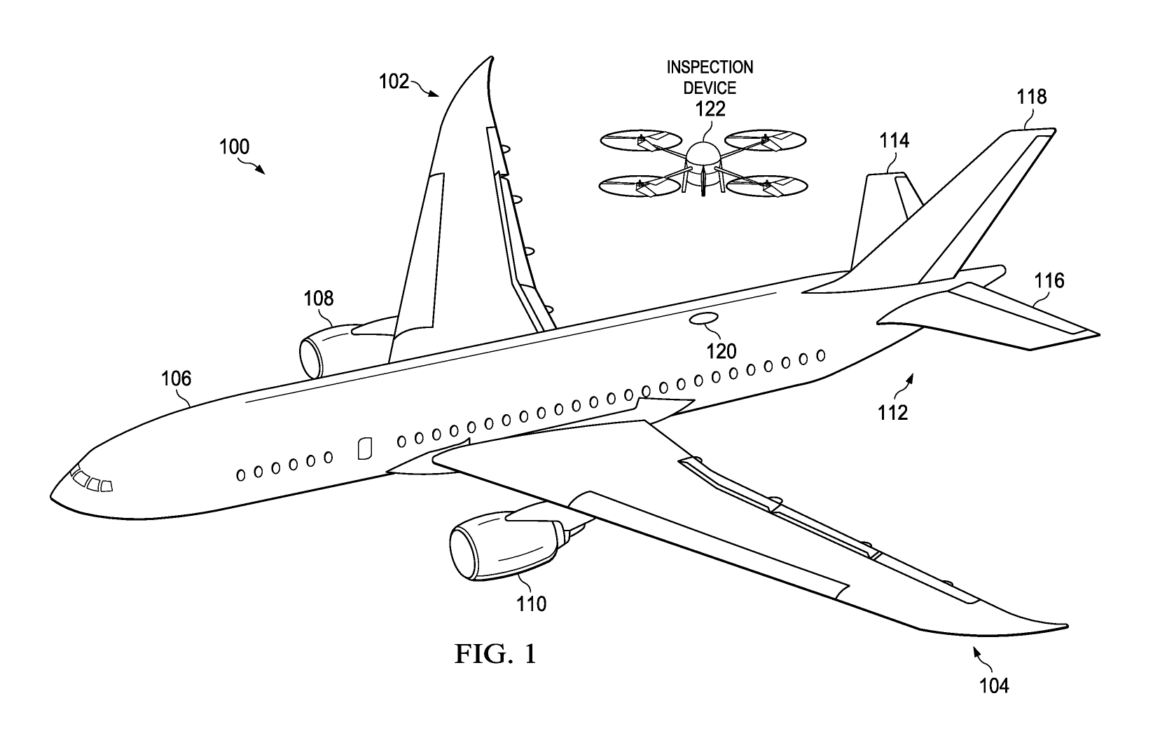

FIG. 1 is an illustration of an aircraft, in accordance with an illustrative embodiment. Aircraft 100 includes wing 102 and wing 104 attached to fuselage 106; engine 108 attached to wing 102; and engine 110 attached to wing 104. Fuselage 106 has tail section 112. Horizontal stabilizer 114, horizontal stabilizer 116, and vertical stabilizer 118 are attached to tail section 112 of fuselage 106.

Aircraft 100 may be struck by lightning during operation, or even while on the ground. Lightning strikes may cause inconsistency 120. Particularly on modern aircraft made of composite materials, inconsistency 120 may be difficult to detect, requiring careful visual inspection or possibly non-destructive inspection techniques of the interior of the material that makes up aircraft 100. In some cases, inconsistency 120 may need to be reworked in order to remove inconsistency 120 or properly replace the composite material in the area of inconsistency 120. In other cases, inconsistency 120 may simply be noted and monitored for possible reworking at a later date.

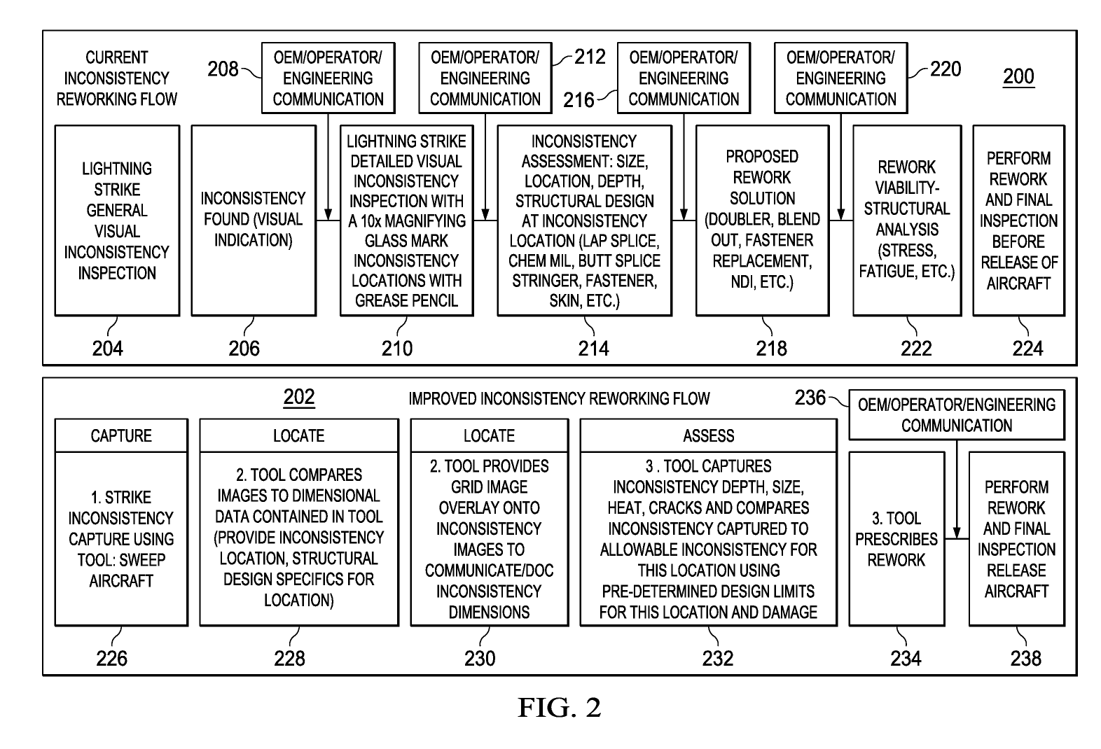

As indicated further in FIG. 2, manual visual inspection is tedious, time consuming, and expensive. Thus, the illustrative embodiments provide for an automated inconsistency detection system. In particular, inspection device 122 may be used to scan the entirety of (or portions of) aircraft 100. In an illustrative embodiment, inspection device 122 may be a flying machine such as an unmanned aerial vehicle. In another illustrative embodiment, inspection device 122 may be a robot that uses a robotic arm to move a camera and/or other sensor over the surface of aircraft 100. Operation of inspection device 122 is described in more detail below.

Inspection device 122 may be characterized as an autonomous data capture device for capturing data on aircraft 100. Inspection device 122 may also be characterized as a lightning-induced inconsistency aircraft dispatch mobile disposition tool.

Inspection device 122 is capable of three-dimensional location mapping and may overlay a grid on aircraft 100. Inspection device 122 may correlate images of aircraft 100 and inconsistency 120 to design data on the normal or expected features of aircraft 100. Inspection device 122 has on-board sensors usable to triangulate an inconsistency location and correlate to design data.

Inspection device 122 may have a screen, may project information to be displayed on a remote screen, or may project information directly on to a surface, such as the surface of aircraft 100. The screen image or transmitted image shows the inconsistency location and nature. The displayed images may include drawings or images of what the site normally looks like, may transmit images of the inconsistency itself, and may transmit data such as inconsistency size (in terms of any or all of area, depth, or percent of missing material), as well as data taken by an on-board micrometer, visual imaging technology, heat sensors, or other sensors.

Inspection device 122 may transmit damage information to remote devices and may internally accesses design data. Inspection device 122 may record inconsistencies, perform trending or tracking of inconsistencies, and monitor crack growth propagation from previous inconsistencies and reworking. Thus, inspection device 122 may be characterized as a smart tool that provides recommendations for allowable limits on tolerating detected inconsistencies and also provides logic for suggesting recommended reworking.

FIG. 2 is an illustration of a flowchart comparing current lightning-induced inconsistency reworking techniques with current lightning-induced inconsistency reworking techniques, in accordance with an illustrative embodiment. Both method 200 and method 202 may be performed on an aircraft, such as aircraft 100 of FIG. 1. However, method 200 represents the old, manual procedure for performing lightening-induced inconsistency assessment and reworking. Method 202 represents the new procedure provided for by the illustrative embodiments.

Attention is first turned to method 200. Initially, a lightning strike general visual inconsistency inspection is performed (operation 204). An inconsistency is found by a visual indication (operation 206). Communication of the inconsistency is then made to an OEM (original equipment manufacturer), such as the aircraft manufacturer; an operator, such as the aircraft operator; and/or an engineering department of either entity or by a third entity (operation 208). Next, a lightning strike detailed visual inconsistency inspection with a 10 power magnifying glass is performed, with inconsistency locations marked with a grease pencil (operation 210). Again, OEM, operator, and engineering communication takes place (operation 212) for the new information.

Next, an inconsistency assessment is performed, assessing the size, location, depth, and structural design at the inconsistency location (including possibly any or multiple ones of: lap splice information, chem mil information, butt splice information, stringer information, fastener information, skin information, and others) (operation 214). Again, OEM, operator, and engineering communication takes place (operation 216).

Next, the technicians performing the inconsistency assessment proposes a rework solution, such as but not limited to a doubler, blend out, fastener replacement, non-destructive inspection, and others (operation 218). Again, OEM, operator, and engineering communication takes place (operation 220).

Then, the technicians perform reworking viability analysis and structural analysis, such as but not limited to stress, fatigue, and others (operation 222). The technicians then perform the reworking and then perform a final inspection before release of the aircraft to operation (operation 224). In all, flow 224 may involve more than a person-week of time by trained professionals, with multiple time choke points caused by multiple communication requirements. A “person-week” is defined as a total number of hours worked by one or more people that adds up to the number of hours in a work week, such as 40, or possibly even 60 or 80 hours. Thus, if ten people worked 4 hours each, then the total hours worked is 40 hours, which would be a “person-week.”

Attention is now turned to method 202. Method 202 may be performed by a lighting-induced inconsistency assessment tool, such as inspection device 122 of FIG. 1.

Initially, the tool performs a strike inconsistency capture by sweeping the aircraft (operation 226). This operation may involve the tool taking images or using other sensors such as micrometers, voltmeters, heat sensors, or other sensors to gather data about the surface of the aircraft.

Next, the tool itself compares images to dimensional data contained in the tool, thereby providing inconsistency location, and structural design specifics for the location (operation 228). The tool then provides a grid image overlay (either on a display screen and/or projected onto the aircraft) to communicate and document dimensions of the inconsistency (operation 230). The tool then captures inconsistency depth, size, heat characteristics, cracks, and possibly other parameters and compares the assessed inconsistency to allowable inconsistencies for the given location using pre-determined design limits for that location and that type of inconsistency (operation 232). This operation may be performed while the tool continues to inspect other areas of the aircraft. The tool then prescribes a recommended rework for the inconsistency (operation 234). Alternatively or in addition, the tool may recommend that the inconsistency be monitored, or reworked within a predetermined time frame.

Only at this point, possibly after all inspection is completed, does the tool communicate information to the OEM, the operator, or the engineering personnel (operation 236). Thus, the tool saves several communication operations relative to method 200. Additionally, the information may be wirelessly transmitted, thereby also increasing the efficiency of communication.

After consultation, technicians then perform the rework, a final inspection, and release the aircraft to service (operation 238). Thus, the tool saves considerable time and reduces the amount of time and money spent on inspecting and reworking the aircraft.

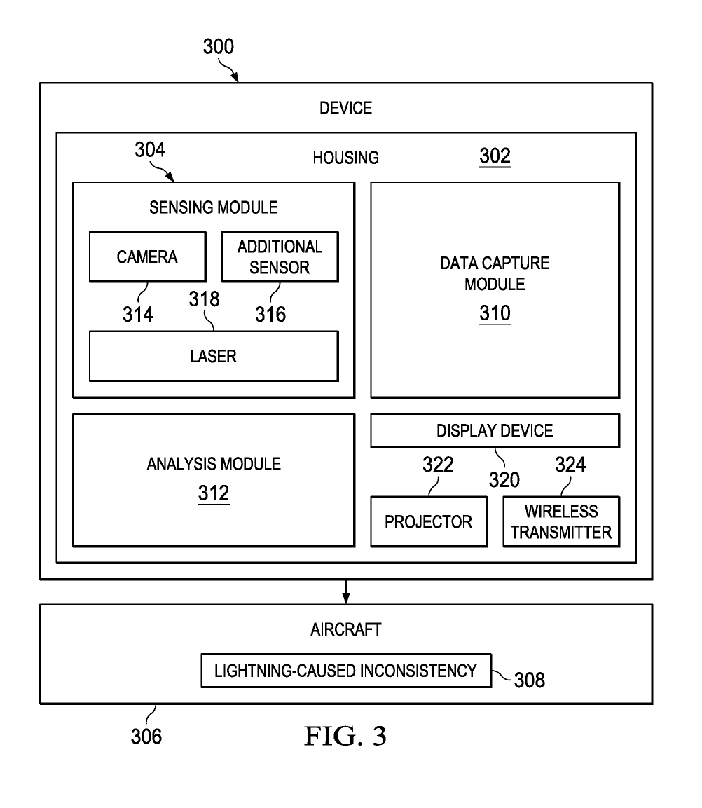

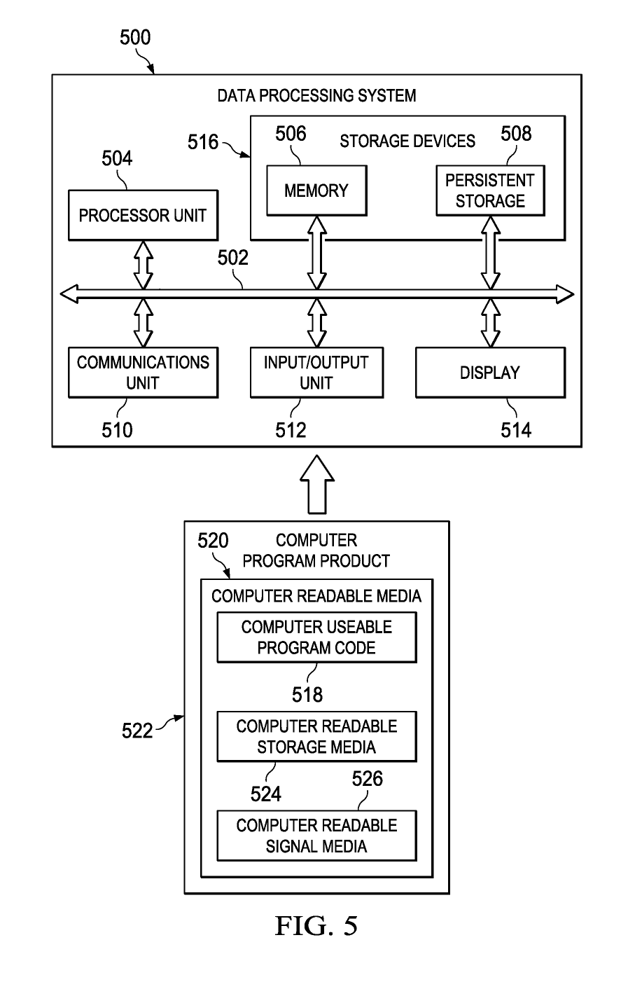

FIG. 3 is an illustration of a block diagram of a device for performing lightning-induced inconsistency assessment and benchmarking, in accordance with an illustrative embodiment. Device 300 is an example of inspection device 122 of FIG. 1. Device 300 may be used to implement method 202 of FIG. 2. Device 300 may include a computer or other integrated circuits, such as data processing system 500 of FIG. 5.

Device 300 includes housing 302. Device 300 also includes sensing module 304 in housing 302 and is configured to detect lightning-caused inconsistency 308 on aircraft 306. Sensing module 304 may be one or more different data capturing devices, such as but not limited to cameras, micrometers, heat sensors, color sensors, volt meters, infrared detectors, ultrasound devices, lasers for inducing an ultrasound response in the aircraft material, and other devices.

Device 300 also includes data capture module 310 in housing 302 and configured to capture images of lightning-caused inconsistency 308. Data capture module 310 may be a non-transitory computer recordable storage medium, a computer, or a wired or wireless transmitter for transmitting data to a remote storage facility.

Device 300 also includes analysis module 312 in housing 302 and is configured to characterize characteristics of lightning-caused inconsistency 308 using the images and to compare the characteristics to a preexisting data set. The preexisting data set is normal conditions of aircraft 306.

Analysis module 312 may be a computer, such as data processing system 500 of FIG. 5. Analysis module 312 may also include software for performing the functions described herein, such as taking the data from data capture module 310 or sensing module 304 and comparing that data to preexisting data related to normal conditions of the aircraft.

Device 300 may be varied. For example, in an illustrative embodiment, sensing module 304 may include camera 314 and/or one or more additional sensors, such as additional sensor 316. In this case, data capture module 310 may be further configured to capture sensor data from additional sensor 316. Additionally, analysis module 312 may be further configured to use both the sensor data and the images to characterize characteristics. Additional sensor 316 may be at least one device selected from the group consisting of: a heat sensor, a conductivity sensor, and a micrometer configured to sense a depth of lightning-caused inconsistency 308.

In another related illustrative embodiment, sensing module 304 is configured to sense heat inconsistencies, metallic aberrations, and structural abnormalities in the aircraft. In this case, sensing module 304 includes laser 318 and camera 314 captures the images in three dimensions using three-dimensional laser mapping. The metallic aberrations may be at least one of a conductivity change and a mass redistribution within the material that make up aircraft 306.

In another illustrative embodiment, device 300 also includes display device 320 on the housing and configured to display areas of lightning-caused inconsistency 308 on aircraft 306 based on a comparison of the characteristics of lightning-caused inconsistency 308 to the preexisting data set. In another illustrative embodiment, possibly in addition to display device 320, device 300 may also include projector 322 on housing 302 and configured to project a display of structural configuration information overlaid on areas of lightning-caused inconsistency 308 on aircraft 306 based on a comparison of the characteristics to the preexisting data set.

In a related illustrative embodiment, device 300 also includes wireless transmitter 324 in housing 302. Wireless transmitter 324 may be configured to transmit data for displaying the display as a three-dimensional grid with the structural elements of aircraft 306 on a remote display system. Additionally, wireless transmitter 324 in housing 302 may be configured to transmit data regarding lightning-caused inconsistency 308 to an outside inconsistency analysis resource.

In another illustrative embodiment, device 300 may be one of a hand-held or mounted to an autonomous inspection device. Thus, device 300 may be an unmanned aerial vehicle or other autonomously controlled device. In this case, device 300 further includes motor connected housing 302 and a lifting system connected to the motor and configured to cause the unmanned aerial vehicle to fly. An example of a lifting system could be wings, propellers, helicopter blades, jets, or other means for aerospace propulsion.

In a different illustrative embodiment, analysis module 312 may be further configured to determine whether aircraft 306 is airworthy in view of lightning-caused inconsistency 308. In this case, analysis module 312 may be configured to display a recommendation as to whether lightning-caused inconsistency 308 should be reworked prior to operating aircraft 306.

Device 300 may be further varied. Thus, the illustrative embodiments are not necessarily limited to the examples provided above. For example, more or fewer sensors may be provided, more or fewer processors may be provided, and other functionality may be provided to device 300. Thus, device 300 does not necessarily limit the claimed inventions.

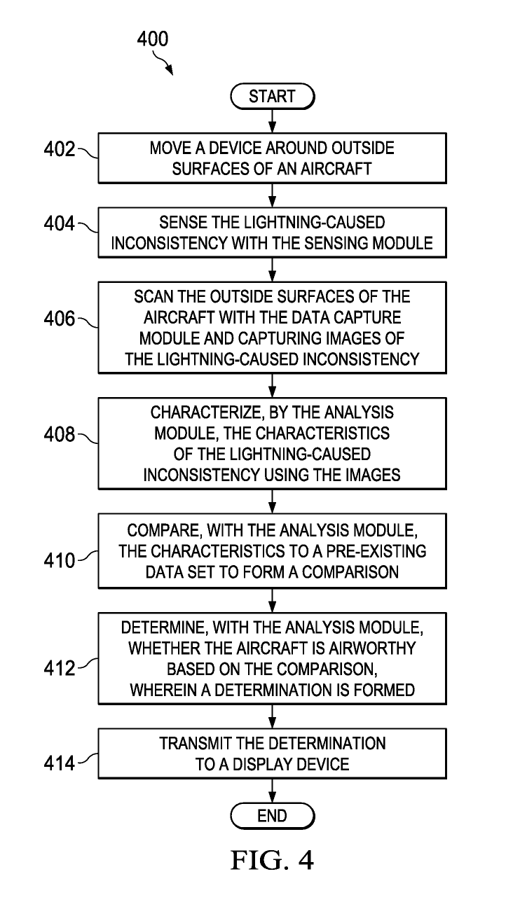

FIG. 4 is an illustration of a flowchart for reworking lightning-induced inconsistencies on an aircraft, in accordance with an illustrative embodiment. Method 400 may be performed using a device such as inspection device 122 of FIG. 1 or device 300 of FIG. 3. Method 400 may be an alternative to method 202 of FIG. 2. Method 400 may be implemented using a data processing system in such a tool, which may be data processing system 500 of FIG. 5.

Method 400 initially begins by moving a device around outside surfaces of an aircraft (operation 402). The device may include a housing; a sensing module in the housing and configured to detect a lightning-caused inconsistency on the aircraft; a data capture module in the housing and configured to capture images of the lightning-caused inconsistency; and an analysis module in the housing and configured to characterize characteristics of the lightning-caused inconsistency using the images and to compare the characteristics to a preexisting data set.

Method 400 then includes sensing the lightning-caused inconsistency with the sensing module (operation 404). Next, method 400 includes scanning the outside surfaces of the aircraft with the data capture module and capturing images of the lightning-caused inconsistency (operation 406). Method 400 then includes characterizing, by the analysis module, the characteristics of the lightning-caused inconsistency using the images (operation 408).

Next, method 400 includes comparing, with the analysis module, the characteristics to a pre-existing data set to form a comparison (operation 410). Method 400 then includes determining, with the analysis module, whether the aircraft is airworthy based on the comparison, wherein a determination is formed (operation 412). Method 400 may also include transmitting the determination to a display device (operation 414). The method may terminate thereafter.

Method 400 may be varied. Method 400 may include more or fewer operations.

For example, the pre-existing data set may be nominal structural data regarding the aircraft. Method 400 may also include projecting and superimposing, using a projector connected to the housing, a three-dimensional grid over an area of the aircraft where the lightning-caused inconsistency is located. In this case, method 400 may also include transmitting, via a transmitter in the housing, the three-dimensional grid for display on the remote display device.

In another illustrative embodiment, method 400 may also include transmitting to the remote display device a recommendation that the aircraft continue to be operated for a predetermined amount of time before the aircraft should receive maintenance for the lightning-caused inconsistency. In a different illustrative embodiment, method 400 may also include transmitting to the remote display device a recommendation regarding limits placed on operation of the aircraft until the aircraft receives maintenance for the lightning-caused inconsistency.

In a still different illustrative embodiment, the device further comprises an unmanned aerial vehicle or other autonomous devices. In this case, moving the device may be flying the unmanned aerial vehicle around the outside surfaces, or moving a robotic arm of a robot to perform a robotic scan of the aircraft. Still other variations of method 400 are possible. Thus, method 400 does not necessarily limit the claimed inventions.

Turning now to FIG. 5, an illustration of a data processing system is depicted in accordance with an illustrative embodiment. Data processing system 500 in FIG. 5 is an example of a data processing system that may be used to implement the illustrative embodiments, such used in inspection device 122 of FIG. 1 or as part of device 300, including analysis module 312 or data capture module 310 of FIG. 3. Data processing system 500 may be used to implement the methods disclosed herein, such as method 202 of FIG. 2 or method 400 of FIG. 4.

In this illustrative example, data processing system 500 includes communications fabric 502, which provides communications between processor unit 504, memory 506, persistent storage 508, communications unit 510, input/output (I/O) unit 512, and display 514. Processor unit 504 serves to execute instructions for software that may be loaded into memory 506. This software may be an associative memory, content addressable memory, or software for implementing the processes described elsewhere herein. Processor unit 504 may be a number of processors, a multi-processor core, or some other type of processor, depending on the particular implementation. A number, as used herein with reference to an item, means one or more items. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, computer useable program code in functional form, and/or other suitable information either on a temporary basis and/or a permanent basis. Storage devices 516 may also be referred to as computer readable storage devices in these examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 is a network interface card. Communications unit 510 may provide communications through the use of either or both physical and wireless communications links.

Input/output (I/O) unit 512 allows for input and output of data with other devices that may be connected to data processing system 500. For example, input/output (I/O) unit 512 may provide a connection for user input through a keyboard, a mouse, and/or some other suitable input device. Further, input/output (I/O) unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for execution by processor unit 504. The processes of the different embodiments may be performed by processor unit 504 using computer implemented instructions, which may be located in a memory, such as memory 506.

These instructions are referred to as program code, computer usable program code, or computer readable program code that may be read and executed by a processor in processor unit 504. The computer useable program code in the different embodiments may be embodied on different physical or computer readable storage media, such as memory 506 or persistent storage 508.

Computer useable program code 518 is located in a functional form on computer readable media 520 that is selectively removable and may be loaded onto or transferred to data processing system 500 for execution by processor unit 504. Computer useable program code 518 and computer readable media 520 form computer program product 522 in these examples. In one example, computer readable media 520 may be computer readable storage media 524 or computer readable signal media 526. Computer readable storage media 524 may include, for example, an optical or magnetic disk that is inserted or placed into a drive or other device that is part of persistent storage 508 for transfer onto a storage device, such as a hard drive, that is part of persistent storage 508. Computer readable storage media 524 also may take the form of a persistent storage, such as a hard drive, a thumb drive, or a flash memory, that is connected to data processing system 500. In some instances, computer readable storage media 524 may not be removable from data processing system 500.

Alternatively, computer useable program code 518 may be transferred to data processing system 500 using computer readable signal media 526. Computer readable signal media 526 may be, for example, a propagated data signal containing computer useable program code 518. For example, computer readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, computer useable program code 518 may be downloaded over a network to persistent storage 508 from another device or data processing system through computer readable signal media 526 for use within data processing system 500. For instance, the computer useable program code stored in a computer readable storage medium in a server data processing system may be downloaded over a network from the server to data processing system 500. The data processing system providing computer useable program code 518 may be a server computer, a client computer, or some other device capable of storing and transmitting computer useable program code 518.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown. The different embodiments may be implemented using any hardware device or system capable of running computer useable program code. As one example, the data processing system may include organic components integrated with inorganic components and/or may be comprised entirely of organic components excluding a human being. For example, a storage device may be comprised of an organic semiconductor.

In another illustrative example, processor unit 504 may take the form of a hardware unit that has circuits that are manufactured or configured for a particular use. This type of hardware may perform operations without needing computer useable program code to be loaded into a memory from a storage device to be configured to perform the operations.

For example, when processor unit 504 takes the form of a hardware unit, processor unit 504 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, computer useable program code 518 may be omitted because the processes for the different embodiments are implemented in a hardware unit.

In still another illustrative example, processor unit 504 may be implemented using a combination of processors found in computers and hardware units. Processor unit 504 may have a number of hardware units and a number of processors that are configured to run computer useable program code 518. With this depicted example, some of the processes may be implemented in the number of hardware units, while other processes may be implemented in the number of processors.

As another example, a storage device in data processing system 500 is any hardware apparatus that may store data. Memory 506, persistent storage 508, and computer readable media 520 are examples of storage devices in a tangible form.

In another example, a bus system may be used to implement communications fabric 502 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 506, or a cache, such as found in an interface and memory controller hub that may be present in communications fabric 502.

Data processing system 500 may also include an associative memory. The associative memory may be in communication with communications fabric 502. An associative memory may also be in communication with, or in some illustrative embodiments, be considered part of storage devices 516. Multiple associative memories may be present.

As used herein, the term “associative memory” refers to a plurality of data and a plurality of associations among the plurality of data. The plurality of data and the plurality of associations may be stored in a non-transitory computer readable storage medium. The plurality of data may be collected into associated groups. The associative memory may be configured to be queried based on at least indirect relationships among the plurality of data in addition to direct correlations among the plurality of data. Thus, an associative memory may be configured to be queried based solely on direct relationships, based solely on at least indirect relationships, as well as based on combinations of direct and at least indirect relationships. An associative memory may be a content addressable memory.

Thus, an associative memory may be characterized as a plurality of data and a plurality of associations among the plurality of data. The plurality of data may be collected into associated groups. Further, the associative memory may be configured to be queried based on at least one relationship, selected from a group that includes direct and at least indirect relationships, or from among the plurality of data in addition to direct correlations among the plurality of data. An associative memory may also take the form of software. Thus, an associative memory also may be considered a process by which information is collected into associated groups in the interest of gaining new insight based on relationships rather than direct correlation. An associative memory may also take the form of hardware, such as specialized processors or a field programmable gate array.

As used herein, the term “entity” refers to an object that has a distinct, separate existence, though such existence need not be a material existence. Thus, abstractions and legal constructs may be regarded as entities. As used herein, an entity need not be animate. Associative memories work with entities.

The different illustrative embodiments can take the form of an entirely hardware embodiment, an entirely software embodiment, or an embodiment containing both hardware and software elements. Some embodiments are implemented in software, which includes but is not limited to forms such as, for example, firmware, resident software, and microcode.

Furthermore, the different embodiments can take the form of a computer program product accessible from a computer usable or computer readable medium providing computer useable program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non-limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or computer usable program code such that when the computer readable or computer usable program code is executed on a computer, the execution of this computer readable or computer usable program code causes the computer to transmit another computer readable or computer usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the computer useable program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems or remote printers or storage devices through intervening private or public networks. Non-limiting examples of modems and network adapters are just a few of the currently available types of communications adapters.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A device comprising:
a housing;
a sensing module in the housing and configured to detect a lightning-caused inconsistency on an aircraft;
a data capture module in the housing and configured to capture images of the lightning-caused inconsistency; and
an analysis module in the housing and configured to characterize characteristics of the lightning-caused inconsistency using the images and to compare the characteristics to a preexisting data set.

2. The device of claim 1, wherein the sensing module further includes an additional sensor, wherein the data capture module further configured to capture sensor data from the additional sensor, and wherein the analysis module is further configured to use both the sensor data and the images to characterize characteristics.

3. The device of claim 2, wherein the sensing module further comprises a camera and wherein the additional sensor comprises at least one selected from the group consisting of: a heat sensor, a conductivity sensor, and a micrometer configured to sense a depth of the lightning-caused inconsistency.

4. The device of claim 3, wherein the sensing module is configured to sense heat inconsistencies, metallic aberrations, and structural abnormalities in the aircraft, and wherein the camera captures the images in three dimensions using three-dimensional laser mapping.

5. The device of claim 4, wherein the metallic aberrations comprise at least one of a conductivity change and a mass redistribution.

6. The device of claim 1, wherein the preexisting data set comprises normal conditions of the aircraft.

7. The device of claim 1 further comprising:
a display device on the housing and configured to display areas of the lightning-caused inconsistency on the aircraft based on a comparison of the characteristics of the lightning-caused inconsistency to the preexisting data set.

8. The device of claim 1 further comprising:
a projector on the housing and configured to project a display of structural configuration information of the aircraft overlaid on areas of the lightning-caused inconsistency on the aircraft based on a comparison of the characteristics to the preexisting data set.

9. The device of claim 8 further comprising:
a wireless transmitter in the housing and configured to transmit data for displaying the display as a three-dimensional grid with the structural configuration information of the aircraft on a remote display system.

10. The device of claim 1, wherein the device is one of hand-held or mounted to an autonomous inspection device.

11. The device of claim 1, wherein the device comprises an unmanned aerial vehicle or other autonomously controlled device and the device further comprises:
a motor connected the housing; and
a lifting system connected to the motor and configured to cause the unmanned aerial vehicle to fly.

12. The device of claim 1, wherein the analysis module is further configured to determine whether the aircraft is airworthy in view of the lightning-caused inconsistency, and to display a recommendation as to whether the lightning-caused inconsistency should be reworked prior to operating the aircraft.

13. The device of claim 1 further comprising:
a wireless transmitter in the housing and configured to transmit data regarding the lighting-caused inconsistency to outside inconsistency analysis resources.

14. A method comprising:
moving a device around outside surfaces of an aircraft, the device comprising:
a housing;
a sensing module in the housing and configured to detect a lightning-caused inconsistency on the aircraft;
a data capture module in the housing and configured to capture images of the lightning-caused inconsistency; and
an analysis module in the housing and configured to characterize characteristics of the lightning-caused inconsistency using the images and to compare the characteristics to a preexisting data set;
sensing the lightning-caused inconsistency with the sensing module;
scanning the outside surfaces of the aircraft with the data capture module and capturing images of the lightning-caused inconsistency;
characterizing, by the analysis module, the characteristics of the lightning-caused inconsistency using the images;
comparing, with the analysis module, the characteristics to a pre-existing data set to form a comparison;
determining, with the analysis module, whether the aircraft is airworthy based on the comparison, wherein a determination is formed; and
transmitting the determination to a remote display device.

15. The method of claim 14, wherein the pre-existing data set comprises nominal structural data regarding the aircraft.

16. The method of claim 14 further comprising:
projecting and superimposing, using a projector connected to the housing, a three-dimensional grid over an area of the aircraft where the lightning-caused inconsistency is located.

17. The method of claim 16 further comprising:
transmitting, via a transmitter in the housing, the three-dimensional grid for display on the remote display device.

18. The method of claim 14 further comprising:
transmitting to the remote display device a recommendation that the aircraft continue to be operated for a predetermined amount of time before the aircraft should receive maintenance for the lightning-caused inconsistency.

19. The method of claim 14 further comprising:
transmitting to the remote display device a recommendation regarding limits placed on operation of the aircraft until the aircraft receives maintenance for the lightning-caused inconsistency.

20. The method of claim 14, wherein the device further comprises an unmanned aerial vehicle or other autonomous device, and wherein moving the device comprises flying the unmanned aerial vehicle around the outside surfaces, or moving a robotic arm of a robot to perform a robotic scan of the aircraft.
